(19) United States
(12) Patent Application Publication
(10) Pub. No.: US 2003/0028883 A1
(43) Pub. Date: Feb. 6, 2003

(54) System and method for using user-specific information to configure and enable functions in remote control, broadcast and interactive systems

(75) Inventors: James A. Billmaier, Woodinville, WA (US); Donald P. De Leva, Seattle, WA (US); Robert E. Novak, Kirkland, WA (US)

Correspondence Address: DIGEO, INC C/O STOEL RIVES LLP, 201 SOUTH MAIN STREET, SUITE 1100, ONE UTAH CENTER, SALT LAKE CITY, UT, 84111, US

(73) Assignee: Digeo, Inc., Kirkland, WA (US)

(21) Appl. No.: 09/918,610

(22) Filed: Jul. 30, 2001

(51) Int. Cl. H04N 5/445; H04N 7/16; H04N 7/173

(52) U.S. Cl. 725/46; 725/6; 725/110; 725/60

(57) ABSTRACT

According to the invention, techniques for using user-specific information to configure and enable functions in remote control broadcast and interactive systems. In specific embodiments, the user-specific information can be used to facilitate purchasing items electronically, for example. In other embodiments, the user-specific information can be used to complete a call for assistance in case of an emergency, select favorite material for viewing, or control access to content, such as adult entertainment. For example, in select specific embodiments, the user-specific information can be used for restricting access to sexually explicit material over electronic delivery media. In various specific embodiments, the user-specific information can also include information about persons other than the user, to which the user has a particular relationship. For example, information such as a mother's favorite flower, or a child's clothing size, and the like may be stored for a particular user. In specific embodiments, the present invention provides a remote access device that is configured to accept a smart card. The smart card has user modifiable information relevant to completing transactions for goods or services, for example, stored thereon. In various specific embodiments, a second plurality of user-specific information may be received and stored on a smart card, providing user interactive controlled modifiability to the information on the smart card.

### BACKGROUND OF THE INVENTION

The present invention relates generally to remote control, broadcast, and interactive systems, and in particular to techniques for using user-specific information to configure and enable functions in a consumer updatable smart card for use with interactive television systems, and techniques for interactively loading data onto such a smart card using a remote control.

At a time when many in our society are enjoying increasing productivity in their work environment, in large part the benefit of the investment in new technology, somewhat paradoxically, leisure time has become a premium commodity. Sadly, free time to enjoy entertainment, or to shop for goods for ones self or others has become a scarce luxury. It seems that every day, demands on the individual and the family arise, barring the enjoyment of quality time together. Accordingly, Americans seek more easily enjoyed forms of entertainment than ever before in history.

One type of entertainment device that has experienced wide acceptance is the television. Television has become one of the most widespread mediums for broadcasting content to a viewer. Almost every house in the United States and in most other developed countries has access to a television. Families congregate around the television to enjoy movies, sitcoms, instructional programming, comedy shows, and more. Conventional television may receive its signals from a content broadcast source via cable, satellite, antenna, or other device. The channels are “tuned” either by the television itself or by a set top box. Content is provided by a plurality of content broadcast sources, in return for advertising revenue. One of the ways a content broadcast source derives revenue is through the sale of time slots for commercial advertising. A company promoter pays for a time slot during a particular broadcast, such as a movie or a sitcom, to promote a company product. The company promoter relies on the power of the advertisement to motivate each viewer either to travel to a store to purchase the product or to order the product via telephone or Internet connection.

One recent advance to television technology is the onset of interactive television and web-enabled television. These technologies enable a viewer to select content, to view content, to request information pertaining to content, to identify preferred advertising, to access web content, to access video game downloads, and more. Interactive television provides a more attractive entertainment medium than the traditional television.

While certain advantages to conventional approaches are perceived, opportunities for further improvement exist. For example, according to conventional television technology, a variety of people from different purchasing demographics may be watching the same television program, and thus view the same advertising. Accordingly, many of the viewers may be disinterested in the advertised product, which leads to inefficient use of the viewer's entertainment time, as well as the advertiser's advertising expenditures. Further, a potential customer's motivation to purchase an advertised good or service may not last long enough after viewing an advertisement to effect the transaction. Again, this leads to inefficient use of time and money. Another disadvantage to conventional television systems is that there is typically no mechanism to enforce restrictions on viewing of adult programming content by minors. In typical conventional systems, there is not the possibility to block access to certain types of programming by someone other than a continuously present adult.

What are needed are improved techniques for techniques for using user-specific information to configure and enable functions in consumer updatable smart cards for use with interactive television systems, and techniques for interactively loading data onto such a smart card using a remote control in interactive television based entertainment and commerce systems.

### BRIEF DESCRIPTION OF THE DRAWINGS

Non-limiting and non-exhaustive embodiments of the present invention are described with reference to the following figures, wherein like reference numerals refer to like parts throughout unless otherwise specified.

FIG. 1 illustrates a block diagram of a representative example interactive broadcast network in a specific embodiment of the present invention.

FIG. 2A illustrates a block diagram of a representative example interactive television system client in a specific embodiment of the present invention.

FIG. 2B illustrates a block diagram of a representative example interactive client system client in another specific embodiment of the present invention.

FIG. 3 illustrates a block diagram of a representative example remote control in a specific embodiment of the present invention.

FIG. 4 illustrates a block diagram of a representative example set top box in a specific embodiment of the present invention.

FIG. 5 illustrates a block diagram of a representative example smart card in a specific embodiment of the present invention.

FIG. 6 illustrates a block diagram of a representative example of user-specific information in a specific embodiment of the present invention.

FIG. 7 illustrates a flowchart of a representative example process of using a smart card in a specific embodiment of the present invention.

FIG. 8A illustrates a flowchart of a representative example process of controlling a viewer's access to information using a smart card in a specific embodiment of the present invention.

FIG. 8B illustrates a flowchart of a representative example process of shopping using a smart card in a specific embodiment of the present invention.

FIG. 8C illustrates a flowchart of a representative example process of effecting a sale transaction automatically in a specific embodiment of the present invention.

FIG. 9 illustrates a flowchart of a representative example process of authenticating user identity in a specific embodiment of the present invention.

FIG. 10A illustrates a flowchart of a representative example user-specific information management process in a specific embodiment of the present invention.

FIG. 10B illustrates a flowchart of another representative example user-specific information management process in a specific embodiment of the present invention.

### DESCRIPTION OF THE SPECIFIC EMBODIMENTS

The present invention provides techniques for using user-specific information to configure and enable functions in remote control broadcast and interactive systems. Embodiments according to the present invention provide various techniques for using user-specific information to configure and enable functions in consumer updatable smart cards for use with interactive television systems, and techniques for interactively loading data onto such a smart card using a remote control in interactive television based entertainment and commerce systems.

In specific embodiments, the user-specific information can be used to facilitate purchasing items electronically, for example. In other embodiments, the user-specific information can be used to complete a call for assistance in case of an emergency, select favorite material for viewing, or control access to content, such as adult entertainment. For example, in select specific embodiments, the user-specific information can be used for restricting access to sexually explicit material over electronic delivery media. In specific embodiments, the present invention provides user interactive, set top box controlled modifiability to user-specific information stored on a smart card. In various specific embodiments, the user-specific information can also include information about persons other than the user, to which the user has a particular relationship. For example, information such as a mother's favorite flower, or a child's clothing size, and the like may be stored for a particular user. One or more specific embodiments can provide enhanced convenience, communicative efficiency and data security over conventional approaches.

In a representative embodiment, the present invention provides a method. The method includes receiving a first plurality of user-specific information. The method also provides for storing the first plurality of user-specific information. The first plurality of user-specific information can be stored on a smart card, for example. Receiving a first indication of user intention to enter into a first transaction is part of the method, as well. Further, the method includes evaluating the first indication of user intention to enter into a first transaction in order to select a first plurality of specific instances of information from the first plurality of user-specific information based upon relevance to the first transaction. The method also includes creating a first transaction request based upon the first indication of user intention to enter into a transaction and the first specific instances of user-specific information. Then, according to the method, the first transaction request is sent. In specific embodiments, the present invention provides a remote access device that is configured to accept a smart card. The smart card has user modifiable information relevant to completing transactions for goods or services, for example, stored thereon. In various specific embodiments, a second plurality of user-specific information may be received and stored on a smart card, providing user interactive, set top box controlled modifiability to the information on the smart card.

In another representative embodiment, the present invention provides an apparatus. The apparatus comprises: a processor; a working memory; a persistent storage; a head end communications device; a transceiver; and a bus. The bus interconnects the processor, the working memory, the persistent storage, the head end communications device and the transceiver. The transceiver is operative to provide communications with a remotable device. Further, a smart card having user modifiable information relevant to completing transactions stored thereon is operatively coupled to the remotable device. Alternatively, or in addition, the smart card may be coupled to the apparatus in various specific embodiments.

As used herein, the term transaction is intended to be broadly construed to cover a wide variety of requests for services, including, but not limited to, one or more of: accessing a web site; accessing a source of programming; making a purchase of goods or services; making a sale of goods or services; placing goods or services up for auction; borrowing money; lending money; uploading information from a smart card to a head end; downloading information from a head end to a smart card; uploading information from a smart card to a set top box; downloading information from a set top box to a smart card; and making a request for help. Other types of transactions will be readily apparent to those skilled in the art.

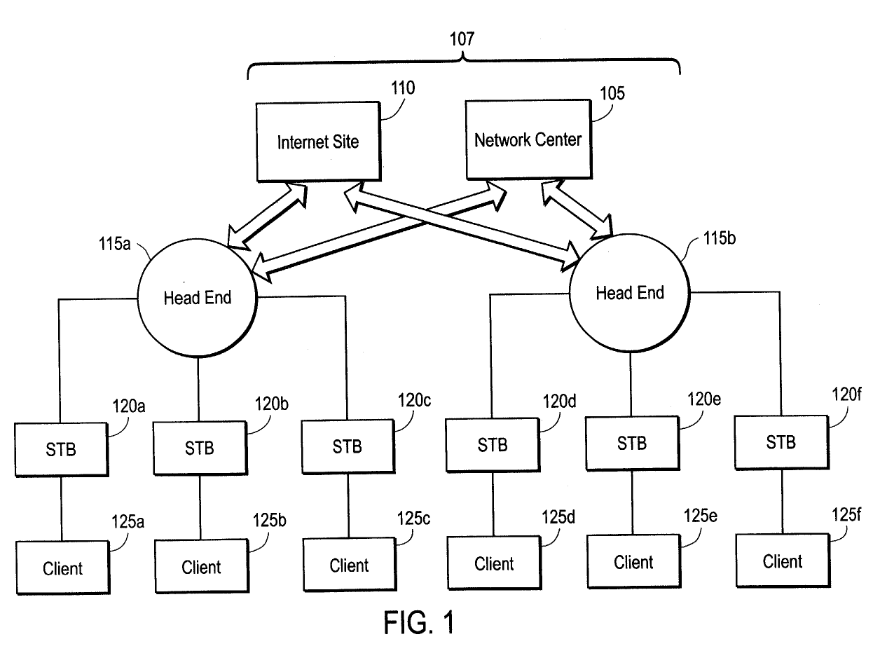

FIG. 1 illustrates a block diagram of a representative example interactive broadcast network in a specific embodiment of the present invention. As FIG. 1 shows, an example embodiment includes a network 100 having an Internet site 110, or other network-based content broadcast source, and a television network center 105, such as NBC, CBS, CNN, or other content broadcast source, each of which can be coupled to one or more head ends, such as head end 115a and head end 115b, collectively and/or individually referred to herein as head end 115. Each of the Internet site 110 or the network center 105 may be referred to as a “content broadcast source 107.” Each head end 115 may be coupled to one or more set top boxes (STB), including set top boxes 120a-120f, collectively and/or individually referred to herein as set top box 120. One skilled in the art will recognize that the network 100 may include different clients, such as web-enabled or interactive television sets, televisions, computers, or other electronic devices, for example, connected to the set top boxes 120. One skilled in the art will also recognize that the set top boxes 120 may be connected to the Internet site 110 or to the network center 105 using a variety of connection techniques. For example, in a specific embodiment, the clients may be connected to the content broadcast source 107 directly, omitting head end 115. The connection between the set top box 120 and the head end 115 may use telephone lines, cable, satellite, wireless, or other communication mechanisms in various specific embodiments. For simplicity and convenience, representative embodiments of the present invention will be described generally with reference to FIG. 1. However, various specific embodiments of the present invention may be realized using any of a wide variety of network configurations.

One or more of the content broadcast sources 107 provide content to the set top boxes 120. In the case of the Internet site 110, the content may be in the form of web pages, and the like, for example. In the case of the network center 105, the content may be in the form of movies or sitcoms. It will be appreciated that, in either case, the content broadcast source 107 may transmit interactive content, such as, for example, a product offering, instructional video or a video request form, and the like. It will be appreciated that the interactive content may request user-specific information, such as user-identification information, contact information, financial information, size information, and the like, for example. It will be appreciated that the request for user-specific information need not originate at a content broadcast source 107. For example, the head end 115 or the set top box 120 may originate an information request.

One or more of the head ends 115 communicates information between the content broadcast source 107 and the set top boxes 120. One or more of the set top boxes 120 receives content from a corresponding head end 115, as well as transmits information to the corresponding head end 115. In a specific embodiment, the set top boxes 120 can enable a viewer/user to interact via the head end 115 with the Internet 110 in order to browse network sites, and so forth, with the network center 105 in order to provide functions and features such as a capability to select movies, to designate preferred advertisements, or to purchase products being offered.

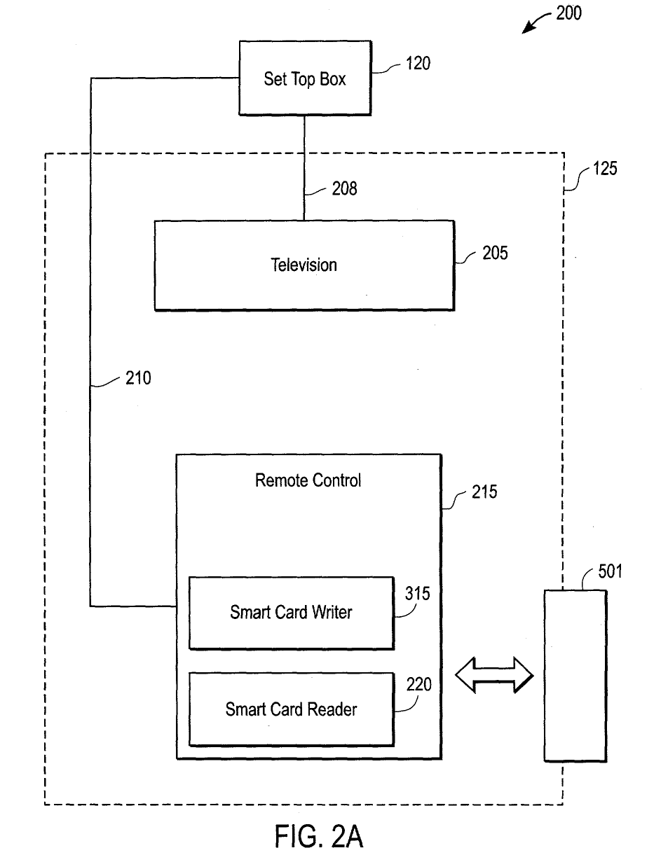

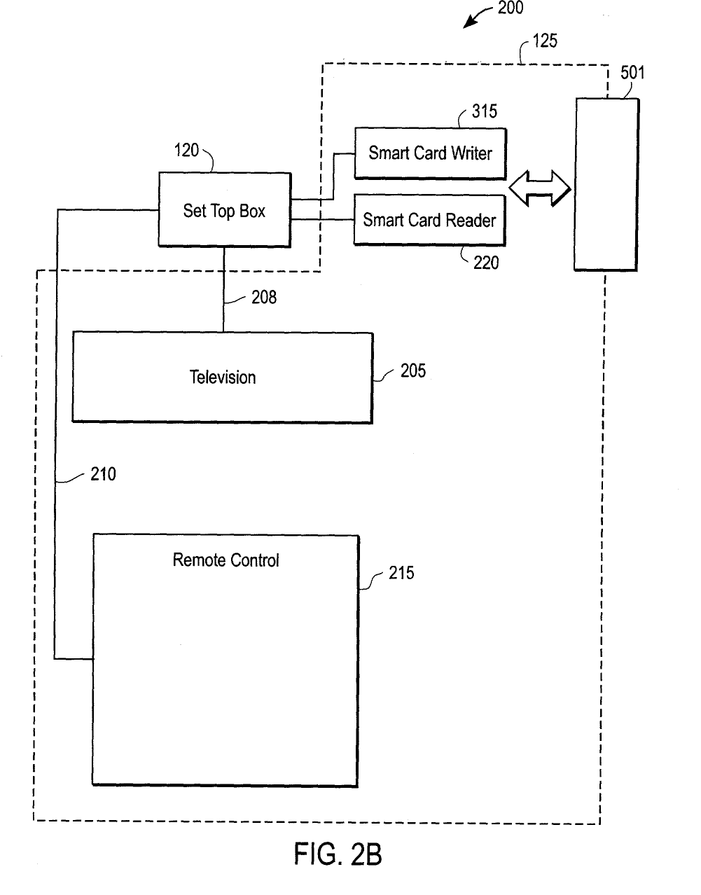

FIG. 2A illustrates a block diagram of a representative example interactive television system client in a specific embodiment of the present invention. The representative client side 200 of a specific embodiment of an interactive television system illustrated by FIG. 2A can be located within someone's home, office, place of business, or the like, for example. Example client side 200 includes a set top box 120, which is communicatively coupled to a client 125, comprising a television 205 and a remote control 215. In a specific embodiment, set top box 120 is communicatively coupled by, for example, a wireless connection 210 to remote control 215. Further, a wired connection 208 couples set top box 120 to television 205 of client 125. In specific embodiments, the remote control 215 includes a smart card reader 220 and/or a smart card writer 315 adaptable to receive a smart card 501. The smart card reader 220 may be used to convey user-specific information stored on the smart card 501 to the set top box 120, and the smart card writer 315 may be used to modify user-specific information stored on the smart card 501 under control of the set top box 120, and/or the remote control 215.

FIG. 2B illustrates a block diagram of another representative example interactive television system client in a specific embodiment of the present invention. As shown in FIG. 2B, the example client side 200 includes a set top box 120, which is communicatively coupled to a client 125, comprising a television 205 and a remote control 215. In a specific embodiment, set top box 120 is communicatively coupled by, for example, a wireless connection 210 to remote control 215. Further, a wired connection 208 couples set top box 120 to television 205 of client 125. A smart card reader 220 and/or smart card writer 315 can be located within or coupled to the set top box 120 to provide interface to smart card 501.

It will be appreciated that, in specific embodiments in which the client side 200 includes a smart card reader 220 and/or smart card writer 315 for reading and writing user-specific information to smart cards, new functionality may be achieved. For example, the client side 200 can provide personalization of the remote control 215, personalization of the set top box 120, and so forth. Personalization capability can provide enhanced automatic purchasing of advertised products, selection of favorite channels, restricting viewer access to particular channels, and other functionality in various specific embodiments.

In an alternative embodiment, the smart card reader 220 and/or smart card writer 315 may be located within television 205, for example. Many other possible locations for the smart card reader 220 and/or the smart card writer 315, such as in a separate device or devices, are available in various specific embodiments. However, for convenience, specific embodiments will be described generally with reference to the configurations illustrated by FIGS. 2A-2B.

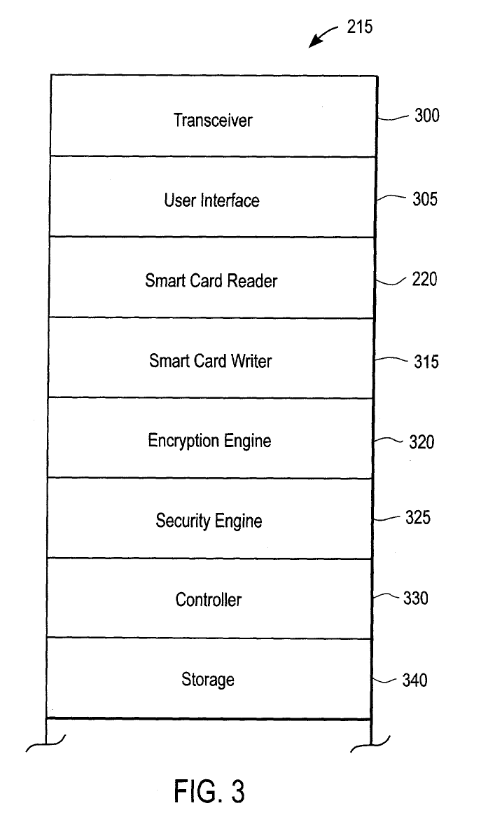

FIG. 3 illustrates a block diagram of a representative remote control in a specific embodiment of the present invention. In the specific embodiments illustrated by FIG. 3, the remote control 215 includes a transceiver 300, a user interface 305, a smart card reader 220, a smart card writer 315, an encryption engine 320, a security engine 325, a controller 330, and storage 340. In various specific embodiments, remote control 215 may include other components not shown. Further, in some specific embodiments, one or more of the components illustrated by FIG. 3 may be omitted.

The transceiver 300 establishes data communication between the remote control 215 and the set top box 120. The transceiver 300 may, for example, transmit information, such as, for example, commands, data, executables, and the like, to the set top box 120 as well as receive information, such as, for example, commands, data, executables, and the like, from the set top box 120. The communication between the remote control 215 and the set top box may be wireless, or a wire connection in various specific embodiments. Further, any of a variety of data protocols and connection methods may be used. For example, in specific embodiments using wireless communications, the medium may be Infrared (IR), radio frequency, or the like. In specific embodiments that employ a wire connection, a serial, parallel, or other connection may be used.

The user interface 305 enables a user to interface with the remote control 215. The user interface 305 permits the user to enter numbers and text into the remote control 215. The user interface 305 may include, for example, conventional alphanumeric buttons, a keyboard, touch pad, touch screen, mouse, track ball, specialized keys, such as a key for requesting a sales transaction, or a dedicated “911” button, or a voice recognition tool.

The controller 330 controls information requests received from the user interface 305 or from the set top box 120. For efficient configuration of the set top box 120, the controller 330 may be configured to automatically transmit to the set top box 120 certain user-specific information from an installed smart card 501. For example, if the smart card 501 stores a user's favorite channels, the controller 330 may automatically request that the stored favorite channels from the smart card 501 be transmitted to the set top box 120. In other specific embodiments, information such as banking information, content viewing restrictions, or the like can be stored on the smart card 501 for retrieval to be loaded into the set top box 120. Thus, the set top box 120 can enable these channels or functions. Alternatively, the controller 330 may wait for user or set top box 120 instructions. In another example, the user may request to purchase an advertised product either by making an appropriate input into user interface 305, or otherwise. In response, the controller 330 may request that the necessary information be extracted from the smart card 501 and be transmitted. It will be appreciated that, like many components described herein, the controller 330 may be implemented in hardware and/or software in various specific embodiments.

The smart card reader 220 interfaces with the smart card 501. For example, when the set top box 120 receives an information request from a content broadcast source 107, the set top box 120 forwards the request via the transceiver 300 to the controller 330 of the remote control 215. Assuming authorization has already been established, the controller 330 instructs the smart card reader 220 to retrieve the requested information, either automatically or upon user confirmation, from the smart card 501. The controller 330 then instructs the transceiver 300 to transmit the retrieved information to the set top box 120, which in turn transmits the information to the content broadcast source 107. In another embodiment, the set top box 120 may originate a request, such as, for example, a request to enable favorite channels or a request to enable only specific authorized channels in order to limit children's access, for example. This request can be originated based upon information from the smart card 501, such as the age of the owner of the smart card, for example, or a set of viewing restrictions, or the like. In yet another embodiment, the user, via the user interface 305, may originate the request, such as, for example, a request to enable favorite channels or to purchase a product being advertised.

The smart card writer 315 also interfaces with the smart card 501. The smart card writer 315 may be used to modify data stored on the smart card 501. In one embodiment, the set top box 120 may convey user-specific information to the remote control 215 with instructions to modify the information stored on the smart card 501, such as, for example, in the case of financial information controlled by a bank. Alternatively, the remote control 215 may receive information via the user interface 305, such as, for example, in the case of parental control of accessible television channels or websites. Accordingly, the smart card writer 315 may write the information to the smart card 501.

It will be appreciated that the smart card reader 220 and/or the smart card writer 315, and the controller 330 may cooperate with the security engine 325 to ensure that only an authorized party is accessing or using the smart card 501. For example, after insertion of the smart card 501, the controller 330 may launch the security engine 325 to request user identification and password. Until a recognized and authorized user identification and password combination is received, the security engine 325 may deny access to the smart card 501. It will be appreciated that the smart card writer 315 may communicate with the security engine 325 to confirm modification rights and/or the encryption engine 320 for storing or retrieving encrypted data on the smart card 501.

It will be appreciated that the transceiver 300 may cooperate with the encryption engine 320. The encryption engine 320 may be used to decrypt information received from the set top box 120 and encrypt information transmitted to the set top box 120. It will be appreciated that the encryption engine 320 may use any of a number of encryption techniques such as public key cryptography, symmetric key cryptography, SSL, and the like.

One skilled in the art will recognize that the remote control 215, the smart card reader 220, and/or the smart card writer 315 may be organized in a variety of ways in various alternative embodiments. For example, in a specific embodiment, the remote control 215 may be a one-way remote control that includes only a smart card reader 220, but no smart card writer 315. In such embodiments, the remote control 215 transmits information retrieved from the smart card 501. However, in other specific embodiments, the remote control 215 includes full duplex capability that enables the remote control 215 to transmit as well as receive information to and from the set top box 120.

In a specific embodiment, the user interface 305 may include a dedicated “911” button. For example, depression of the button may indicate a request for emergency dispatch of an ambulance to a person's home. Alternatively, depression of the button may request information to be sent to a person's doctor or parent. Programmable or configurable embodiments can provide the user with the option of selecting from among such actions to be triggered by the “911” button. The user interface 305 may transmit the request to the controller 330, which instructs the smart card reader 220 to retrieve stored user identification, health information, address information and/or other information. Alternatively or additionally, the remote control 215 or set top box 120 itself may store address information. Stored address information can be useful to provide the capability to use a smart card 501 with a friend's remote control 215 in instances where the smart card user may be visiting at a friend's house, for example. The controller 330 can automatically send an emergency message including the user health and address (either or both) information to the emergency dispatch service or other person. One skilled in the art will recognize that any emergency dispatch input device can be additionally or alternatively used. For example, in specific embodiments, the user interface 305 may include speech recognition, remote receivers, and the like. In one embodiment, the transmitter device (not shown) may be included, for example, in a pacemaker type device (not shown), which sends an emergency dispatch request to the remote receiver when the pacemaker device recognizes certain heart events.

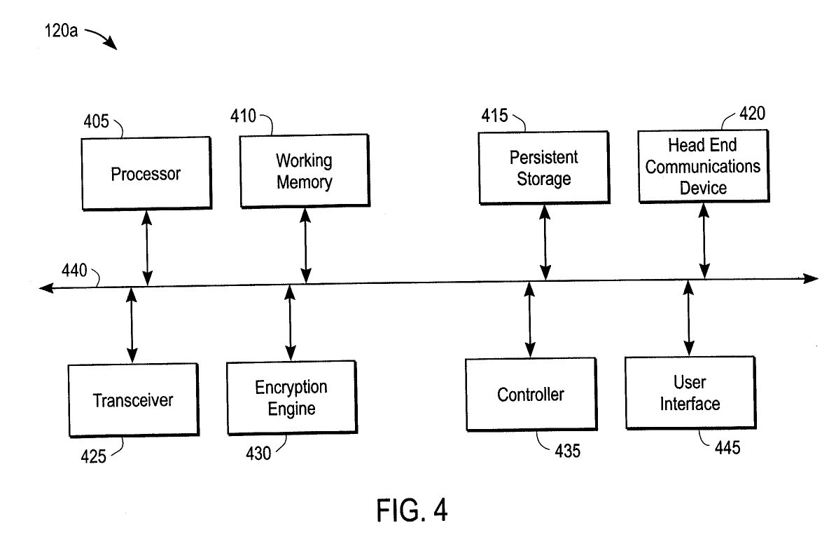

FIG. 4 illustrates a block diagram of a representative example set top box in a specific embodiment of the present invention. As shown in FIG. 4, representative set top box 120a includes a processor 405, which can be an Intel Pentium® microprocessor or a Motorola Power PC® microprocessor, or the like, for example, coupled to a communications channel 440. The set top box 120a further includes a working memory 410, which can be RAM, for example, a persistent storage 415, such as a hard drive, a head-end communications device (transceiver) 420, a transceiver 425, an encryption engine 430, a controller 435, and a user interface 445, each coupled to the communications channel 440. It will be appreciated that the terms “memory” and “storage” herein are intended to cover any data storage media, whether persistent or temporary, fixed or removable, tape, disk, or semiconductor.

The head end communications device 420 enables communications between the set top box 120a and the head end 115a, for example. In a representative specific embodiment, the head end communications device 420 may include a parser, an MPEG standard transport stream, an MPEG decoder chip, and chips for audio decoding and processing, for example.

The transceiver 425 communicates information to and from the transceiver 300 of the remote control 215. In representative example embodiments, this information may include one or more of commands, data, executables, and so forth.

The user interface 445 receives information into the set top box 120a directly from the user. For example, to avoid transmitting restricted information, such as passwords or personal identification numbers (PINs), the information may be entered directly into the set top box 120a via the user interface 445, rather than into the remote control 215 via the user interface 305. In various embodiments, the user interface 445 may include for example a keyboard, a voice identification system, mouse, touch pad, touch screen, track ball, joystick, or the like.

The controller 435 may be hardware and/or software. Controller 435 processes information being communicated to and/or from the set top box 120a, whether with the head end communications device 420, with the transceiver 425 or with the user interface 445. For example, when a user requests to purchase an advertised product, the controller 435 instructs the head end communications device 420 to transmit the request to the content broadcast source 107. In various specific embodiments, other information may also be included in the request, such as user identification information, financial information and delivery address information, or the like, for example. When the controller 435 receives the purchase request from the content broadcast source 107, the controller 435 instructs the television 205 to display a receipt including, for example, a confirmation number.

It should be noted that, in specific embodiments, an Internet site 110 may send code for installation in the set top box 120a, in the remote control 215 or in the smart card 501. In some embodiments, instructions to install the code and/or an installer may be sent as well. The controller 435 in the set top box 120a controls whether the received code is installed in the set top box 120a, or forwarded to the controller 330 of the remote control 215. If the code is intended for the remote control 215, the controller 330 of the remote control 215 stores and installs the code on the remote control 215. Alternatively, the controller 330 instructs the smart card writer 315 to write and install the code on the smart card 501. This enables specific embodiments to perform code updates and add functionality to the remote control 215 and smart card 501.

In specific embodiments, the controller 435 may operate in conjunction with the encryption engine 430. The encryption engine 430 encrypts messages being sent either to the content broadcast source 107 or to the remote control 215, as appropriate. Also, the encryption engine 430 decrypts messages being received either from the remote control 215 or from the content broadcast source 107, as appropriate.

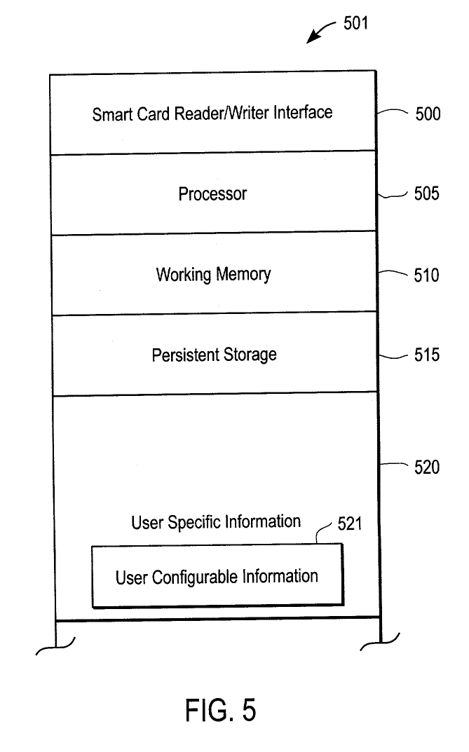

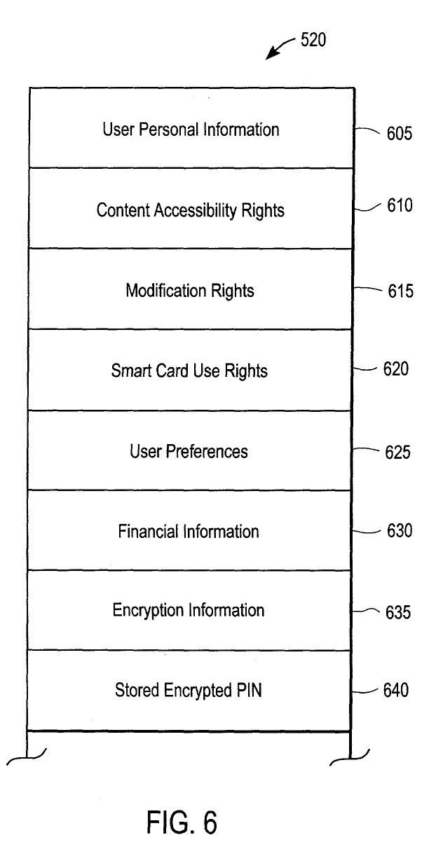

FIG. 5 illustrates a block diagram of a representative example smart card in a specific embodiment of the present invention. As shown in FIG. 5, smart card 501 includes a smart card reader/writer interface 500, a processor 505, a working memory 510, a persistent storage 515, and user-specific information 520. The smart card reader/writer interface 500 interfaces with the smart card reader 220 and/or smart card writer 315 once docked. The user-specific information 520 includes user-configurable information 521, which may be all or at least a portion of the user-specific information 520. Examples of user-specific information in various specific embodiments will be described with reference to FIG. 6.

FIG. 6 illustrates a block diagram of a representative example of user-specific information in a specific embodiment of the present invention. As shown in FIG. 6, representative examples of user-specific information 520 may include user personal information 605, content accessibility rights 610, modification rights 615, smart card use rights 620, user preferences 625, financial information 630, encryption information 635, stored encrypted PINs 640, and the like. In some specific embodiments, not all of the types of user-specific information illustrated by FIG. 6 may be present. Further, in select specific embodiments, other types of user-specific information can be included, as will be apparent to those skilled in the art.

Personal user information 605 may include user name, user phone numbers, contact and delivery address information, health information, clothing sizes, age, favorite colors, flavors, and the like. In some specific embodiments, personal user information 605 can include information about one or more persons other than the user. For example, a shopper can obtain a copy of a bridal registry for a friend from the head end 115a, or other source, for example. Once the bridal registry information is downloaded into the shopper's smart card, the shopper can use the bridal registry information to shop for gifts for the friend. Content accessibility rights 610 include information for preventing a user from accessing certain channels. For example, a parent or guardian can limit what a minor user can view. The minor user is blocked from modifying the content accessibility rights until the minor becomes of age, or is otherwise emancipated. Modification rights 615 include permissions to allow users, such as the parents, guardians or banks issuing a cash card, to modify the information on the smart card while forbidding others. Smart card use rights 620 indicate who is allowed to use the particular card and may include user ID and password combinations. User preferences 625 may include favorite channels. User preferences 625 may also include information regarding user's preferred shopping sites or his other shopping preferences such as color or brand of a particular product. Financial information 630 may include a user's credit card information or user spending limits. Encryption information 635 may include the user's public and private keys, encryption algorithms, or user certificates.

In specific embodiments, a stored encrypted PIN 640 may be used to determine user authorization to access the smart card 501. For example, the user may enter a password into the set top box 120. The encryption engine 430 of the set top box 120 may encrypt the password using, for example, the user's public key. The stored encrypted PIN 640 may be transmitted using a wireless connection 210, for example, from the smart card 501 via the remote control 215 to the set top box 120, and compared against the encrypted entered password. If they match, authorization may be granted. This system enables user authentication without wireless transmission of the unencrypted password that otherwise could be intercepted.

In specific embodiments, the smart card writer 315 provides the user and the institutions associated with the user with the capability to interact with the smart card 501 and update the user-specific information 520 stored on the smart card 501. User personal information 605, such as user's clothing sizes and address or user's preferences 625, may change with time. The inclusion of the smart card writer 315 in specific embodiments permits the user to modify these pieces of information on the smart card 501 as they change with time. Other types of data stored on the smart card 501 may need to be modified by other parties to reflect a change in the user's situation. For example, a bank may wish to modify the quantity of funds or credit or other financial information 630 related to the user that is reflected by the smart card 501. All or some of the various categories of information stored on the smart card 501 may be interactively modified and updated by the user or other entities authorized to do so.

It will be appreciated, however, that before allowing smart card data modification, the smart card writer 315 and/or the smart card itself may be configured to permit only certain users to modify the data, or certain users to modify only certain data types, and the like. For example, the smart card 501 may contain permissions to allow only particular individuals, such as parents or guardians, for example, to update a child's shopping allowance or the accessible television channels. Such modifications would be inaccessible to anyone else, including the child or siblings. As another example, the smart card 501 may contain permissions to allow only a particular financial institution to modify the spending limit available. Some categories of information stored on the smart card 501, for example the stored encrypted PIN 640 or the encryption information 635 may be set to block modification.

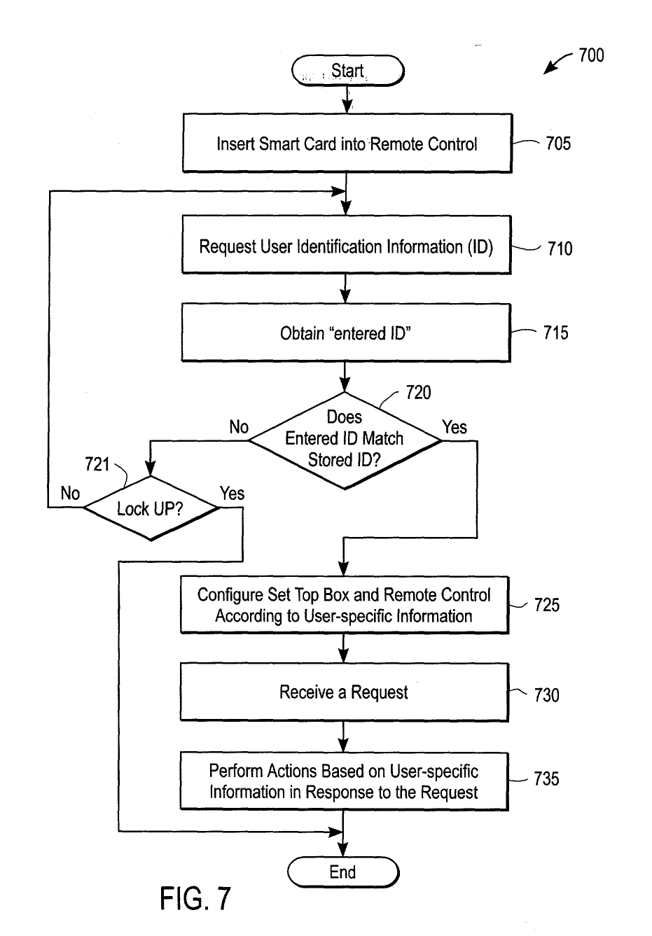

FIG. 7 illustrates a flowchart of a representative example process of using a smart card in a specific embodiment of the present invention. In FIG. 7, a flowchart 700 depicts a process of installing and using a smart card in a specific embodiment is shown. The smart card 501 is inserted 705 into the remote control 215. The security engine 325, at the request of the controller 330 or otherwise, requests 710 smart card use rights information from the user via the user interface 305. Use rights information can include a user ID and password combination, for example, in a representative embodiment. It is appreciated by one of ordinary skill in the art that the smart card use rights information may come in various other forms, for example, thumbprints, voice prints, or retinal scans in various specific embodiments. The user interface 305 obtains 715 the entered smart card use rights information. The security engine 325 requests stored smart card use rights information 620, or an encrypted PIN 640, from the smart card 501 to compare against the entered smart card use rights information. The security engine 325 determines 720 whether the entered smart card use rights information matches the stored smart card use rights information 620 or encrypted PIN 640.

If the security engine 325 determines 720 that they do not match, then the security engine 325 next determines 721 whether to lock up because a maximum number of attempts has been reached, for example, thereby suggesting that an unauthorized user is trying to access the smart card 501. If not time to lock up, the security engine 325 returns to requesting 710 use rights information. If time to lock up, the security engine 325 denies any access for a preset duration of time or until the lock mechanism is overridden.

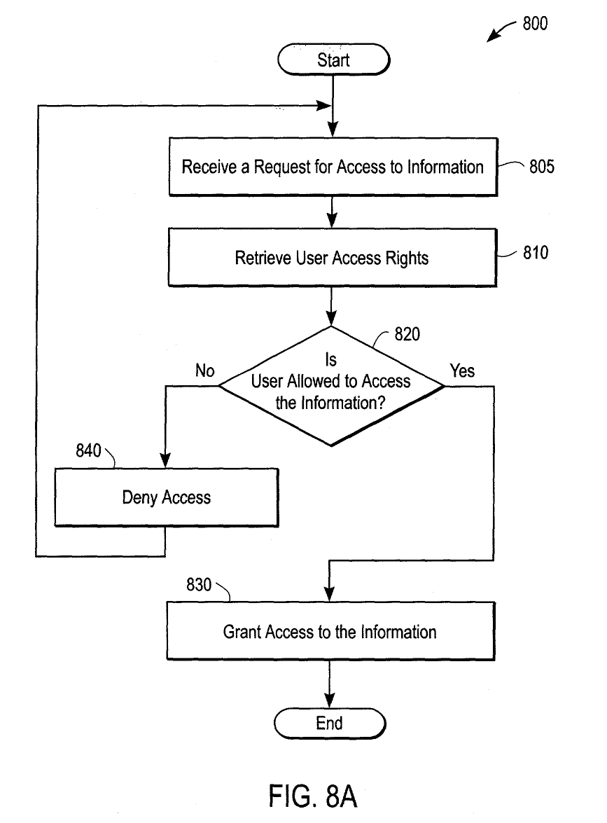

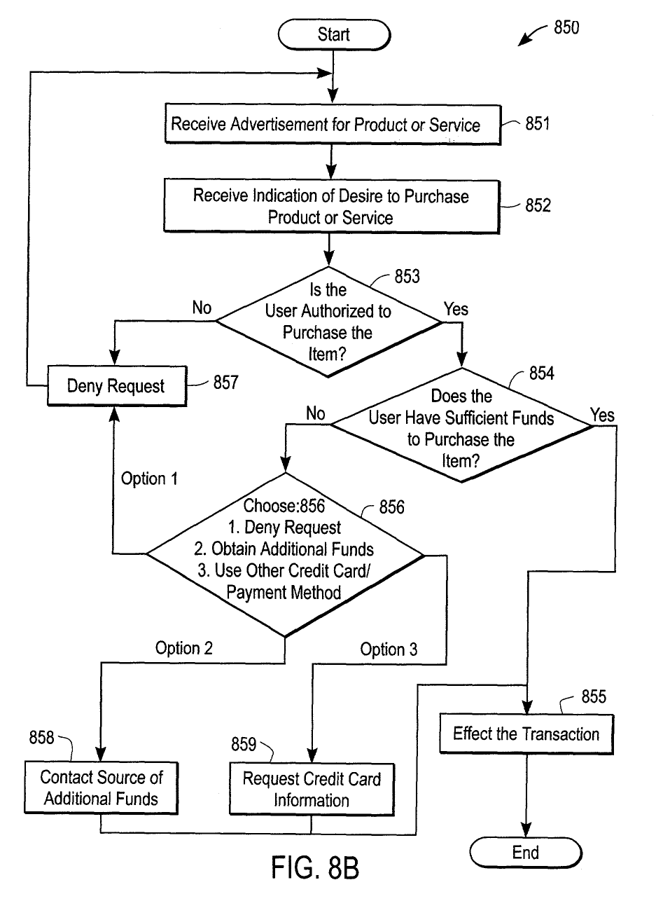

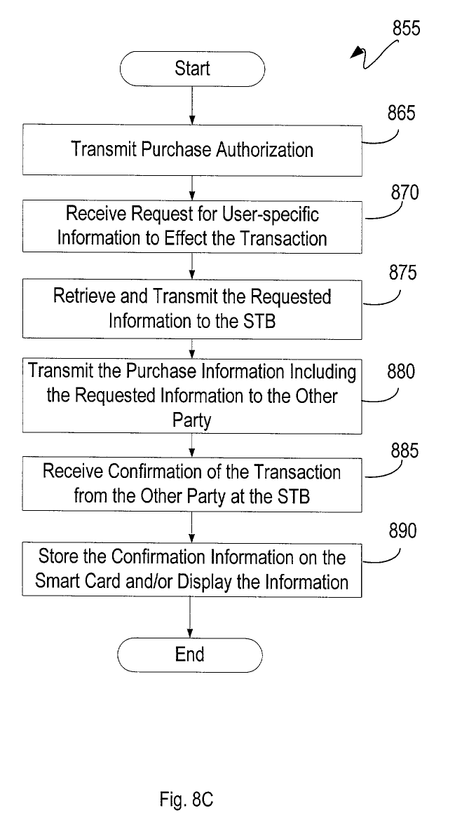

If the security engine 325 determines 720 that the entered smart card use rights information matches the stored smart card use rights information 620, or encrypted PIN 640, the controller 330 configures 725 the set top box 120 and the remote control 215 according to the user-specific information 520 on the smart card 501. For example, the controller 330 may automatically request that favorite and authorized channels be transmitted to the set top box 120. Alternatively, the controller 330 may send a ready flag to the controller 435 of the set top box 120 to indicate a readiness to accept requests, such as a request for favorite and authorized channels. Accordingly, the controller 330 of the remote control 215 receives 730 a request for a particular task from the user or the set top box 120, directly or indirectly, and responds 735 by performing actions based on the user-specific information 520 on the smart card 501. It will be appreciated that receiving 730 and responding 735 represent a variety of possible functions. Representative examples of some of a wide variety of functions possible associated with receiving 730 and responding 735 in various specific embodiments will be described with reference to FIGS. 8A-8C.

In specific embodiments, enhanced mobility can be provided to the smart card user. In some specific embodiments, inserting the smart card 501 in a remote control 215 at a friend's house will configure the friend's remote control 215 and television 205 in accordance with the user's user-specific information, rather than according to the preprogrammed information of the friend who owns the television 205 and the remote control 215. Accordingly, purchases conducted using the friend's system will meet the requirements, size, color, etc., of the user and will be delivered to the user's delivery address and not the friend's.

In specific embodiments, the information exchanged between the remote control 215 and the set top box 120 can be encrypted in case the information is intercepted by a third party desiring to compromise the connection between the remote control 215 and set top box 120. Encryption can be useful in embodiments in which currency value is stored on smart card 501. Symmetric or asymmetric encryption techniques may be used in various specific embodiments. A web-enabled set top box 120 may obtain public key and authentication information and encryption protocols from certification sites such as Verisign®, so that the set top box can encrypt the information when the user is away from his house. The user's private key may be stored on the smart card 501.

In the case of user verification, many different techniques can be used. One example embodiment includes transmitting the encrypted form of the PIN from the smart card 501 to the set top box 120, so that the unencrypted PIN may not be intercepted while in transmission. In specific embodiments where the user enters the PIN directly into the set top box 120, the set top box 120 encrypts the entered PIN and compares the encrypted entered PIN with the stored encrypted PIN 640.

FIG. 8A illustrates a flowchart of a representative example process of controlling a viewer's access to information using a smart card in a specific embodiment of the present invention. As shown in FIG. 8A, a flowchart 800 of a process for enabling access to broadcast content from a content broadcast source 107, for example, can be used to limit children from viewing unauthorized content, and the like. The user interface 305 of the remote control 215 receives 805 a user request for access to content, such as, a channel having sexually explicit material. The controller 330 requests the smart card reader 220 to retrieve 810 the content accessibility rights 610 from the user-specific data 520 stored on the smart card 501. Based on the retrieved content accessibility rights 610, the controller 435 of the set top box 120 or the controller 330 of the remote control 215 determines 820 whether the user is allowed to access the content requested.

If the user does not have rights to access the request content, the controller 330 denies 840 access to the content and the user interface 305 awaits another request, such as, a channel selection. If the user has rights, the controller 330 instructs the transceiver 300 to grant 830 access to the content.

As an example of a specific embodiment, a child user may request access to an improper channel. When the controller 330 receives 805 this request, it retrieves 810 the child user's content accessibility rights 610 from the smart card 501. The child will be denied 840 access. Further, if the smart card 501 is not the child's smart card, then the child may not have received authorization to use the card 501 at all via the smart card use rights 620 query.

FIG. 8B illustrates a flowchart of a representative example process of shopping using a smart card in a specific embodiment of the present invention. In flowchart 850, the set top box 120 receives 851 an advertisement for a product from a content broadcast source 107, for example. The set top box 120 instructs the television 205 or other output device to present the advertisement. The set top box 120 awaits any requests for the product. In this example, the user interface 305 on the remote control 215 receives 852 a product purchase request. The controller 330 determines 853 if the user is authorized to purchase the product requested. In one embodiment, the controller 330 instructs the smart card reader 220 to retrieve the content accessibility rights 610 of the user-specific data 520 stored on the smart card 501. If the controller 330 determines 853 that the user is not permitted, then the controller 330 denies 857 the request and returns to receive 851 another advertisement for a product.

If the controller 330 determines 853 that the user is permitted, then the controller 330 next determines 854 if the user has sufficient funds to make the purchase. In one embodiment, the controller 330 requests the financial information 630 of the user-specific information 520 via the smart card reader 220, for example. If the retrieved financial information 630 indicates that the user has sufficient funds, the controller 330 grants authorization, and the transaction is effected 855. The set top box 120 requests the appropriate information, such as user identification, bank information, size information, delivery address, and the like, from the smart card 501.

As an example of a specific embodiment, a group of children gathered at a friend's house may desire to purchase baseball gloves. Each child may insert his smart card 501 into the remote control 215. The process of a specific embodiment illustrated by flowchart 850 ensures purchase authorization, ensures that the boy has funds to purchase the item, ensures that the glove is of the right size, and ensures that the glove is delivered to the correct address.

If the controller 330 determines 854 that the user does not have sufficient funds, the controller 330 may request that the set top box 120 offer 856 various alternatives to the user. For example, some of the various alternatives that can be offered to a user in specific embodiments include: (1) deny the user's request to purchase the goods; (2) obtain additional funds from the financial institution; and (3) use other sources of funds, such as a credit card, for example. Selecting option (1) results in the request being denied 857. Selecting option (2) may translate to a request for the set top box 120 to communicate 858 with the relevant financial institution, such as a bank, to obtain the necessary authorization for additional funds. Selecting option (3) may translate to a request 859 for the set top box 120 to request alternate credit card information. The alternate credit card information may be stored on the smart card 501, and included as part of the user-specific information 520, for example. Other alternatives can be provided in various specific embodiments as will be readily apparent to those skilled in the art. Effecting a transaction in a specific embodiment will be described with reference to FIG. 8C.

FIG. 8C illustrates a flowchart of a representative example process of effecting a sale transaction automatically in a specific embodiment of the present invention. In an example embodiment of FIG. 8C, effecting a sale transaction of FIG. 8B is illustrated with reference to a flowchart 855. The controller 330, cooperating with the transceiver 300, transmits 865 user authorization to purchase the advertised product. The controller 330 receives 870 a request for user-specific information 520, which can be financial information, user identification information, size information, delivery address information, or the like, in order to effect the transaction. The controller 330, cooperating with the smart card reader 220, the transceiver 300 and optionally the encryption engine 320, retrieves and transmits 875 the requested information from the smart card 501 to the set top box 120. In some specific embodiments, the requested information may be in encrypted format. The set top box 120 transmits 880 the requested information 520 to the other party, which can be an advertiser, the content broadcast source 107, or the like, for example. The set top box 120 receives 885 confirmation of the transaction from the other party. The set top box 120 either requests that the confirmation information be stored on the smart card 501 or displays the confirmation on the television 205, or both.

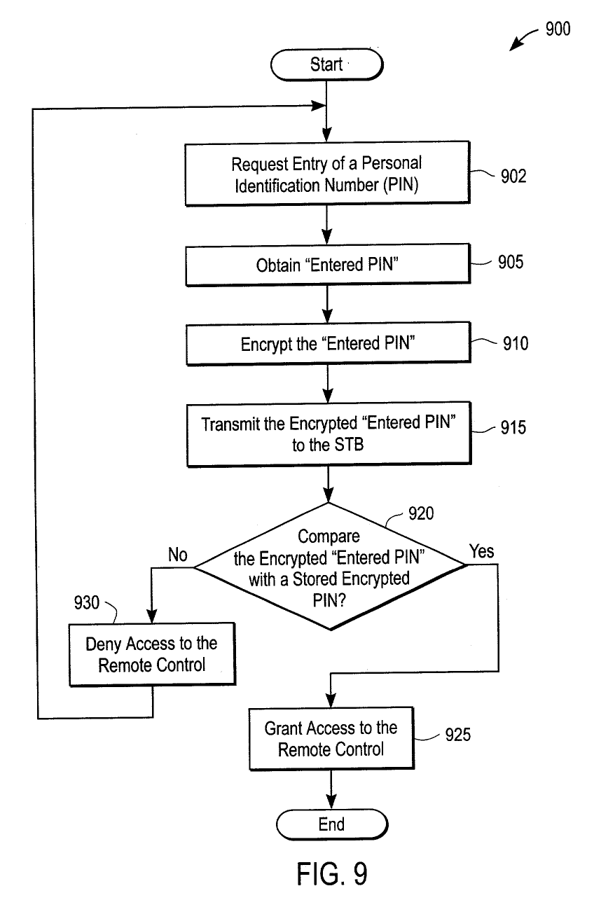

FIG. 9 illustrates a flowchart of a representative example authentication technique in a specific embodiment of the present invention. As shown by flowchart 900, the set top box 120 requests 902 entry of a personal identification number (PIN) by instructing the television 205, or other display device, to display the request. The set top box 120 may initiate this request upon receiving an indication from the remote control 215 that a smart card 501 has been coupled to the remote control 215, or upon detecting the coupling of the smart card 501 with either or both of the smart card reader 220 and/or smart card writer 315. The user interface 305 in the remote control 215 obtains 905 an entered PIN from the user. The encryption engine 320 encrypts 910 the entered PIN to generate an encrypted entered PIN. The security engine 320, cooperatively with the controller 330 and the transceiver 300, transmits the encrypted entered PIN to the set top box 120. Alternatively, the PIN may be entered directly into the set top box 120 via its user interface 445 and encrypted by its encryption engine 430.

The set top box 120 retrieves the stored “correct” encrypted PIN, such as, from a remote location such as from Internet site 110 or from the smart card 501, and compares 920 the stored “correct” encrypted PIN against the encrypted entered PIN to verify the user. If the PINs do not match, then the set top box 120 denies 930 access to the smart card 501. If a match is found, the set top box 120 grants 925 the user access to use the smart card 501 for further operations.

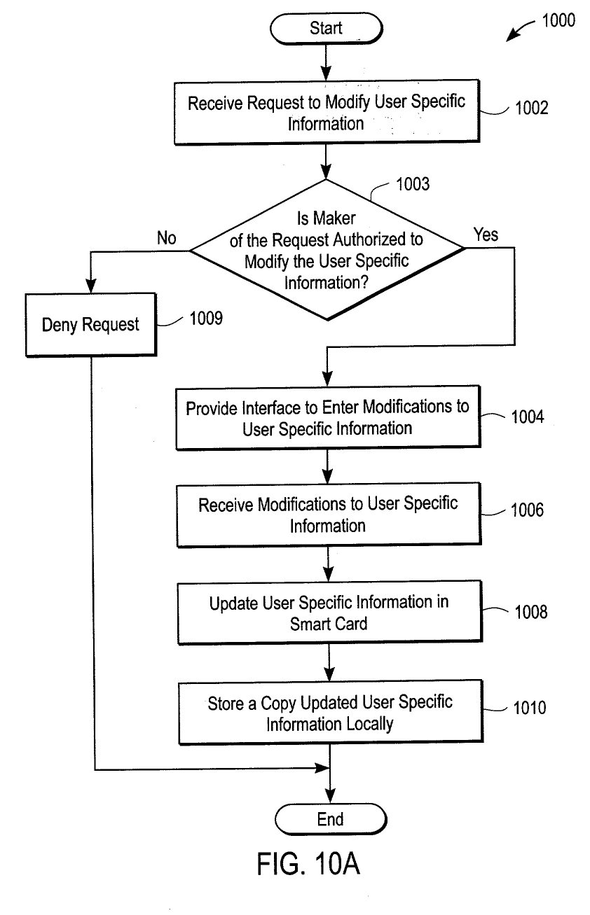

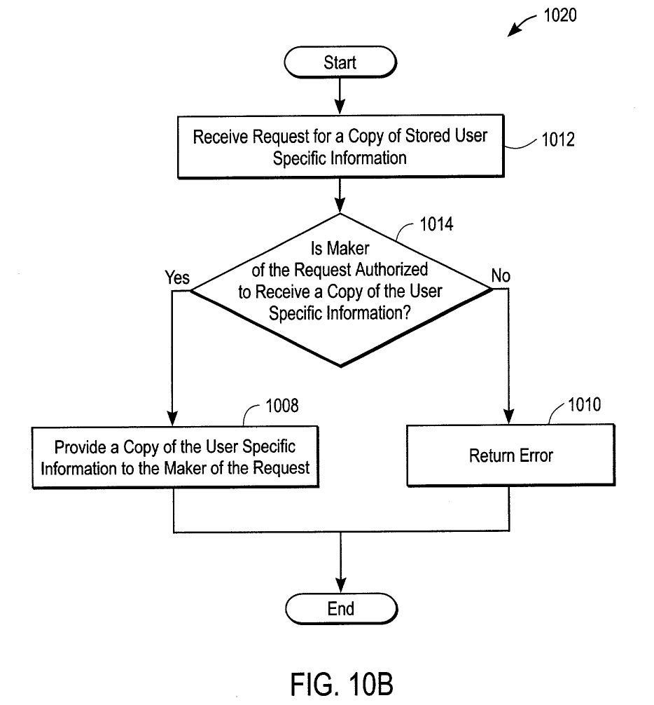

FIG. 10A illustrates a flowchart of a representative example user-specific information management process in a specific embodiment of the present invention. As shown by flowchart 1000, a request to modify user-specific information stored on a smart card 501 is received 1002. A user can enter the request via remote control 215, for example, or directly into the set top box 120. The maker of the request is verified 1003 in order to determine if the maker has authorization to modify the information. If the maker of the request is authorized, then, an interface for entering user-specific information is provided 1004. Otherwise, the request is denied 1009. The interface may be presented on the television 205, or on a display mechanism incorporated into the remote device 215, or set top box 120 in various specific embodiments. An input of modifications to user-specific information is received 1006. The user-specific information on the smart card 501 is updated in accordance with the input 1008. Optionally, in some embodiments, a local copy of the user-specific information may be stored 1010. This can be controlled by the maker of the modification request, the original creator of the information, or otherwise. The copy may be stored in the set top box 120, the remote device 215, or both.

FIG. 10B illustrates a flowchart of a representative example user-specific information management process in a specific embodiment of the present invention. As shown by flowchart 1020, a request for a copy of user-specific information is received 1012. The copy may be stored in the set top box 120, the remote device 215, or both. The request is verified to ensure that the maker of the request is authorized to receive a copy of the requested user-specific information 1014. If the request is authorized, then a copy of the user-specific information is provided to a smart card associated with the maker of the request 1016. Otherwise, an error condition is returned to the maker of the request 1018. The copy of the user-specific information can be stored in a smart card associated with the maker of the request. In a specific embodiment, the techniques illustrated by FIGS. 10A and 10B can be used to obtain user information such as a bridal registry or Christmas list, for example, from the maker of the user-specific information in order to effect shopping for products within the style, taste or need of the recipient.

The foregoing description of the preferred embodiments of the present invention is by way of example only, and other variations and modifications of the above-described embodiments and methods are possible in light of the foregoing teaching. For example, components of this invention may be implemented using a programmed general-purpose digital computer, using application specific integrated circuits, or using a network of interconnected conventional components and circuits. Connections may be wired, wireless, modem, etc.

In the foregoing description, specific details are set forth to provide a thorough understanding of embodiments of the invention. One skilled in the relevant art will recognize that the invention can be practiced without one or more of the specific details, or with other methods, components, or materials. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least that embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The embodiments described herein are not intended to be exhaustive or limiting. The present invention is limited only by the following claims.

What is claimed is:

1. A method for creating a transaction request in an interactive television environment, said method comprising:
receiving a first plurality of user-specific information at a remotable device for interactive television;
storing said first plurality of user-specific information in a smart card;
receiving a first indication of user intention to enter into a first transaction;
evaluating the first indication of user intention to enter into a first transaction to select a first plurality of specific instances of information from said first plurality of user-specific information based upon relevance to the first transaction;
creating a first transaction request based upon the first indication of user intention to enter into a transaction and the first specific instances of user-specific information; and
sending the first transaction request.

2. The method of claim 1, wherein
receiving said first plurality of user-specific information at a remotable device for interactive television comprises receiving said first plurality of user-specific information at a set top box for interactive television.

3. The method of claim 1, wherein
storing said first plurality of user-specific information in a smart card comprises storing said first plurality of user-specific information in a smart card communicatively coupled with said remotable device for interactive television.

4. The method of claim 1, wherein
said first plurality of user-specific information is stored in a smart card interactively under control of a set top box.

5. The method of claim 1, wherein said transaction comprises at least one of:
accessing a web site;
accessing a source of programming;
making a purchase of goods or services;
making a sale of goods or services;
placing goods or services up for auction;
borrowing money;
lending money;
transferring funds;
uploading information from a smart card to a head end;
downloading information from a head end to a smart card;
uploading information from a smart card to a set top box;
downloading information from a set top box to a smart card; and
making a request for help.

6. The method of claim 1, further comprising:
receiving a second plurality of user-specific information;
storing said second plurality of user-specific information;
receiving a second indication of user intention to enter into a second transaction;
evaluating the second indication of user intention to enter into a second transaction to select a second plurality of specific instances of information from said second plurality of user-specific information based upon relevance to the second transaction;
creating a second transaction request based upon the second indication of user intention to enter into a transaction and the second specific instances of user-specific information; and
sending the second transaction request.

7. The method of claim 6, wherein
said second plurality of user-specific information is stored on a smart card interactively under control of a set top box.

8. The method of claim 1, wherein:
user-specific information includes as least one of:
content accessibility rights;
financial information; and
user personal information.

9. The method of claim 8, wherein:
the content accessibility rights includes at least one of:
rights to view an advertisement,
rights to access a web site,
rights to access entertainment programming, and
rights to request a transaction.

10. The method of claim 9, wherein:
content accessibility rights are determined based upon at least one of:
a user's age, and
a user's status within a group.

11. The method of claim 8, further comprising:
determining from a user' content accessibility rights whether the user is subject to restrictions on content; and
if the user is subject to restrictions on content, blocking the user from altering that user's own content accessibility rights.

12. The method of claim 8, wherein:
the financial information includes at least one of:
account identifying information;
information for obtaining funds from a financial institution for a purchase; information for using alternative financial resources for a purchase; and
information for crediting funds received from a transaction.

13. The method of claim 8, wherein:
the user personal information includes at least one of:
identification,
clothing size information,
apparatus size and type information,
user preferences,
delivery address, and
user personal information about a person of interest to the user.

14. The method of claim 8, wherein:
evaluating the first indication of user intention to enter into a first transaction to select a first plurality of specific instances of information from said first plurality of user-specific information based upon relevance to the first transaction for the goods or service comprises at least one of:
determining whether a user has appropriate content accessibility rights;
determining that the user has sufficient funds to request a purchase; and
determining that the user personal information of the user and information about the goods or service do not conflict.

15. The method of claim 14, wherein:
determining that the user has sufficient funds includes at least one of
drawing on funds in a financial institution based upon the financial information;
enabling a user to select an alternate source of payment; and
canceling a transaction if the user is unable to provide sufficient funds.

16. The method of claim 14, wherein:
determining that the user personal information does not conflict with the subject of the advertisement includes at least one of:
checking available sizes of a product subject of the advertisement against user sizes; and
checking available styles of the product against user preferences; and
checking purchase price against user preference for price limits.

17. The method of claim 1, further comprising:
receiving an advertisement for sale or lease of goods or services; and
presenting the advertisement for the sale or lease of the goods or services to a user.

18. A method comprising:
receiving at a client an input indicating an emergency situation;
retrieving user personal information from a smart card communicatively coupled with the client; and
sending an emergency distress signal including the user personal information retrieved from the smart card.

19. The method of claim 18, further comprising:
retrieving user access rights from said smart card;
determining if the holder of the smart card is authorized to send the emergency distress signal based on the user access rights; and
if the holder of the smart card is authorized to send an emergency distress signal, sending the emergency distress signal including the user personal information retrieved from the smart card.

20. The method of claim 18, wherein:
the input is indicated by a user depressing a dedicated 911 button on a remotable device.

21. The method of claim 18, further comprising:
automatically identifying an emergency situation to form the input; and
transmitting the input to a client.

22. The method of claim 21, wherein a transmitter implanted in a user's body transmits the input to the client.

23. The method of claim 18, wherein:
the user personal information includes at least one of:
user location information;
user health information;
user health insurance information; and
user contact information.

24. A system, comprising:
a content broadcast source;
a head end;
a client; and
a remote access device;
wherein the content broadcast source provides information content to the client via the head end;
wherein said remote access device is configured to accept a smart card; the smart card having user modifiable information relevant to completing transactions stored thereon.

25. The system of claim 24, wherein:
the content broadcast source includes at least one of:
an internet site;
a network center; and
an interactive television network center.

26. The system of claim 24, wherein:
the information content comprises:
advertising;
program content;
product or service information; and
public service information.

27. The system of claim 24, wherein the client receives a purchase request.

28. The system of claim 24, wherein:
the client further comprises at least one of:
a set top box;
a television; and
a video player.

29. An apparatus, comprising:
a processor;
a working memory;
a persistent storage;
a head end communications device;
a transceiver;
a bus, interconnecting the processor, the working memory, the persistent storage, the head end communications device and the transceiver;
wherein the transceiver is operative to provide communications with a remotable device; and
wherein the remotable device communicatively couples to a smart card having user modifiable information relevant to completing transactions stored thereon.

30. The apparatus of claim 29, further comprising:
a display monitor.

31. The apparatus of claim 30, further comprising:
a user interface;
wherein the processor causes the display monitor and the user interface to enable altering of the user modifiable information on the smart card.

32. The apparatus of claim 29, further comprising a smart card reader.

33. A set top apparatus, comprising:
means for communicating with a head end;
means for communicating with a remotable device;
means for controlling user modification of information stored on a smart card coupled to the remotable device.

34. A set top apparatus, comprising:
means for communicating with a head end;
means for communicating with a remotable device;
means for coupling with a smart card; and
means for controlling user modification of information stored on the smart card.

35. A remote control, comprising:
means for communicating with a set top box;
means for receiving information from a user;
means for receiving a smart card, said smart card having user modifiable information storable thereon;
means for reading user modifiable information from the smart card; and
means for writing user modifiable information onto the smart card.

36. A method, comprising:
receiving at a set top box a request to modify user-specific information stored on a smart card;
providing an interface into which user-specific information may be entered;
receiving an input of modifications to user-specific information; and
updating user-specific information on the smart card in accordance with the input.

37. The method of claim 36, further comprising:
storing a copy of the user-specific information in said set top box.

38. The method of claim 37, further comprising:
receiving a request for a copy of user-specific information stored at the set top box;
verifying that the request is authorized to receive a copy of the user-specific information; and
if the request is authorized, providing a copy of the user-specific information to a smart card associated with a maker of the request.

39. The method of claim 36, further comprising:
storing a copy of the user-specific information in a head end associated with the set top box.

40. The method of claim 39, further comprising:
receiving a request for a copy of user-specific information stored at the head end;
verifying that the request is authorized to receive a copy of the user-specific information; and
if the request is authorized, providing a copy of the user-specific information to a smart card associated with a maker of the request.

41. A computer program product for creating a transaction request in an interactive television environment, said computer program product comprising:
code that receives a first plurality of user-specific information at a remotable device for interactive television;
code that stores said first plurality of user-specific information in a smart card;
code that receives a first indication of user intention to enter into a first transaction;
code that evaluates the first indication of user intention to enter into a first transaction to select a first plurality of specific instances of information from said first plurality of user-specific information based upon relevance to the first transaction;
code that creates a first transaction request based upon the first indication of user intention to enter into a transaction and the first specific instances of user-specific information;
code that sends the first transaction request; and
a computer readable storage medium for holding the codes.

42. The computer program product of claim 41, wherein
the code that receives said first plurality of user-specific information at a remotable device for interactive television comprises code that receives said first plurality of user-specific information at a set top box for interactive television.

43. The computer program product of claim 41, wherein
the code that stores said first plurality of user-specific information in a smart card comprises:
code that stores said first plurality of user-specific information in a smart card communicatively coupled with said remotable device for interactive television.

44. The computer program product of claim 41, wherein:
said first plurality of user-specific information is stored on a smart card interactively under control of a set top box.

45. The computer program product of claim 41, wherein:
said transaction comprises at least one of:
accessing a web site;
accessing a source of programming;
making a purchase of goods or services;
making a sale of goods or services;
placing goods or services up for auction;
borrowing money;
lending money;
uploading information from a smart card to a head end;
downloading information from a head end to a smart card;
uploading information from a smart card to a set top box;
downloading information from a set top box to a smart card; and
making a request for help.

46. The computer program product of claim 41, further comprising:
code that receives a second plurality of user-specific information;
code that stores said second plurality of user-specific information;
code that receives a second indication of user intention to enter into a second transaction;
code that evaluates the second indication of user intention to enter into a second transaction to select a second plurality of specific instances of information from said second plurality of user-specific information based upon relevance to the second transaction;
code that creates a second transaction request based upon the second indication of user intention to enter into a transaction and the second specific instances of user-specific information; and
code that sends the second transaction request.

47. The computer program product of claim 46, wherein:
said second plurality of user-specific information is stored on a smart card interactively under control of a set top box.

48. The computer program product of claim 41, wherein:
user-specific information includes as least one of:
content accessibility rights;
financial information; and
user personal information.

49. The computer program product of claim 48, wherein:
the content accessibility rights includes at least one of:
rights to view an advertisement,
rights to access a web site,
rights to access entertainment programming, and
rights to request a transaction.

50. The computer program product of claim 49, wherein:
content accessibility rights are determined based upon at least one of:
a user's age, and
a user's status within a group.

51. The computer program product of claim 48, further comprising:
code that determines from a user' content accessibility rights whether the user is subject to restrictions on content; and
if the user is subject to restrictions on content, blocks the user from altering that user's own content accessibility rights.

52. The computer program product of claim 48, wherein:
the financial information includes at least one of:
account identifying information;
information for obtaining funds from a financial institution for a purchase; information for using alternative financial resources for a purchase; and
information for crediting funds received from a transaction.

53. The computer program product of claim 48, wherein:
the user personal information includes at least one of:
identification,
clothing size information,
apparatus size and type information,
user preferences,
delivery address, and
user personal information about a person of interest to the user.

54. The computer program product of claim 48, wherein:
the code that evaluates the first indication of user intention to enter into a first transaction to select a first plurality of specific instances of information from said first plurality of user-specific information based upon relevance to the first transaction for the goods or service comprises at least one of:
code that determines whether a user has appropriate content accessibility rights;
code that determines that the user has sufficient funds to request a purchase; and
code that determines that the user personal information of the user and information about the goods or service do not conflict.

55. The computer program product of claim 44, wherein:
the code that determines that the user has sufficient funds includes at least one of
code that draws on funds in a financial institution based upon the financial information;
code that enables a user to select an alternate source of payment; and
code that cancels a transaction if the user is unable to provide sufficient funds.

56. The computer program product of claim 44, wherein:
the code that determines that the user personal information does not conflict with the subject of the advertisement includes at least one of:
code that checks available sizes of a product subject of the advertisement against user sizes;
code that checks available styles of the product against user preferences; and
code that checks purchase price against user preference for price limits.

57. The computer program product of claim 41, further comprising:
code that receives an advertisement for sale or lease of goods or services; and
code that presents the advertisement for the sale or lease of the goods or services to a user.

58. A computer program product comprising:
code that receives at a client an input indicating an emergency situation;
code that retrieves user personal information from a smart card communicatively coupled with the client;
code that sends an emergency distress signal including the user personal information retrieved from the smart card; and
a computer readable storage medium for holding the codes.

59. The computer program product of claim 58, further comprising:
code that retrieves user access rights from said smart card;
code that determines if the holder of the smart card is authorized to send the emergency distress signal based on the user access rights; and
if the holder of the smart card is authorized to send an emergency distress signal, sends the emergency distress signal including the user personal information retrieved from the smart card.

60. The computer program product of claim 58, wherein:
the input is indicated by a user depressing a dedicated 911 button on a remotable client terminal.

61. The computer program product of claim 58, further comprising:
code that automatically identifies an emergency situation to form the input; and
code that transmits the input to a client terminal.

62. The computer program product of claim 61, wherein:
a transmitter is implanted in a user's body, wherein the transmitter transmits the input to the client terminal under control of the code that transmits the input.

63. The computer program product of claim 58, wherein:
the user personal information includes at least one of:
user location information;
user health information;
user health insurance information; and
user contact information.

64. A computer program product, comprising:
code that receives at a set top box a request to modify user-specific information stored on a smart card;
code that provides an interface into which user-specific information may be entered;
code that receives an input of modifications to user-specific information;
code that updates user-specific information on the smart card in accordance with the input; and
a computer readable storage medium for holding the codes.

65. The computer program product of claim 64, further comprising:
code that stores a copy of the user-specific information in said set top box.

66. The method of claim 65, further comprising:
code that receives a request for a copy of user-specific information stored at the set top box;
code that verifies that the request is authorized to receive a copy of the user-specific information; and
if the request is authorized, provides a copy of the user-specific information to a smart card associated with a maker of the request.

67. The computer program product of claim 64, further comprising:
code that stores a copy of the user-specific information in a head end associated with the set top box.

68. The computer program product of claim 67, further comprising:
code that receives a request for a copy of user-specific information stored at the head end;
code that verifies that the request is authorized to receive a copy of the user-specific information; and
if the request is authorized, provides a copy of the user-specific information to a smart card associated with a maker of the request.
